(19) United States
(12) Patent Application Publication
(10) Pub. No.: US 2016/0161658 A1
(43) Pub. Date: Jun. 9, 2016

(54) Backlight Module and LCD Device

(71) Applicant: Shenzhen China Star Optoelectronics Technology Co. Ltd., Shenzhen, Guangdong (CN)

(72) Inventor: Hu HE, (US)

(73) Assignee: Shenzhen China Star Optoelectronics Technology Co. Ltd., Shenzhen, Guangdong (CN)

(21) Appl. No.: 14/112,543

(22) PCT Filed: Aug. 9, 2013
(86) PCT No.: PCT/CN2013/081126

§ 371 Date: Oct. 17, 2013

(30) Foreign Application Priority Data
Aug. 6, 2013 (CN) 201310339095.5

(51) Int. Cl. F21V 8/00

(52) U.S. Cl. CPC G02B 6/009; G02B 6/0068; G02B 6/0073

(57) ABSTRACT

The present invention proposes an LCD device having a backlight module. The backlight module includes a light guide plate, a first light source unit set up in a corner of a first light-in side of the light guide plate, and a second light source unit set up in a corner of a second light-in side of the light guide plate. The first light-in side is set up in opposition to the second light-in side, and the corner of the second light-in side is in diagonal to the corner of the first light-in side. The present invention provides a backlight module and an LCD device in which light enters the light guide plate in a corner. The entering light mix uniformly in the LGP without dark area, and the number of LED along with expense and energy consumption are reduced compared to that of a single short light-in side backlight module.

### BACKGROUND OF THE INVENTION

1. Field of the Invention

The present invention relates to backlight field, more particularly, to a backlight module and a liquid crystal display (LCD) device.

2. Description of the Prior Art

Thanks to its lightness, thinness, power saving and low radiation, a Liquid Crystal Display (LCD) is widely used in electronic display devices such as computers, mobile phones, electronic dictionary and LCD TVs. As the efficiency of light sources used in LCD devices is improving these years, it has been an inexorable trend to decrease the number of light sources in order to simplify complexity of the backlight module in LCD devices. As FIG. 1 indicates, a backlight module used in an LCD device usually comprises a light guide plate (LGP) 11 and light source units 12 disposed on the sides of the LGP 11. Initially, the LGP includes four light-in sides (shown in FIG. 1a). Then the LGP has developed to have two long light-in sides (shown in FIG. 1b), two short light-in sides (shown in FIG. 1c), single light-in long side (shown in FIG. 1d) and the presently single short light-in side (as in FIG. 1e) in mass production.

With the constant improvement of light sources luminance and for the purpose to further decrease the number of light sources, the single short light-in side in FIG. 1e will inevitably develop to the stage of light-in from corners of the LGP 11. Therefore, it is of vital importance to research and develop a corner light-in backlight module using less light sources.

### SUMMARY OF THE INVENTION

According to the present invention, a backlight module applied in a liquid crystal display (LCD) device comprises a light guide plate (LGP); a first light source unit set up in a corner of a first light-in side of the LGP; a second light source unit set up in a corner of a second light-in side of the LGP; wherein the first light-in side is set up in opposition to the second light-in side, and the corner of the second light-in side is in diagonal to the corner of the first light-in side. An outer side of the first light source unit is aligned with a third side linked to the first light-in side, and a distance between an inner side and the outer side of the first light source unit is no larger than half of a length of the first light-in side, an outer side of the second light source unit is aligned with a fourth side linked to the second light-in side, and a distance between an inner side and the outer side of the second light source unit is no larger than half of a length of the second light-in side.

Furthermore, the first light source unit and the second light source unit are both light emitting diode (LED) light bars comprising a plurality of LEDs.

Furthermore, an angel between a line from a center of an LED closest to the inner side of the first light source unit to a center of an LED closest to the inner side of the second light source and a normal line of the first light-in side satisfies the following formula:

$$θ < {sin}^{- 1} ( \frac{1}{{n}_{L G P}} sin {θ}_{H L A} ) ,$$

wherein θ signifies the angel between the line from the center of the LED closest to the inner side of the first light source unit to the center of the LED closest to the inner side of the second light source and the normal line of the first light-in side, n_{LPG} signifies index of refraction of the LGP, θ_{HLA} signifies a half-intensity viewing angle of the LEDs.

According to the present invention, a backlight module applied in a liquid crystal display (LCD) device comprises a light guide plate (LGP); a first light source unit set up in a corner of a first light-in side of the LGP; a second light source unit set up in a corner of a second light-in side of the LGP. The first light-in side is set up in opposition to the second light-in side, and the corner of the second light-in side is in diagonal to the corner of the first light-in side.

Furthermore, the first light source unit and the second light source unit are both light emitting diode (LED) light bars comprising a plurality of LEDs.

Furthermore, an outer side of the first light source unit is aligned with a third side linked to the first light-in side, and a distance between an inner side and the outer side of the first light source unit is no larger than half of a length of the first light-in side, an outer side of the second light source unit is aligned with a fourth side linked to the second light-in side, and a distance between an inner side and the outer side of the second light source unit is no larger than half of a length of the second light-in side.

Furthermore, an outer side of the first light source unit is aligned with a third side linked to the first light-in side, and a distance between an inner side and the outer side of the first light source unit is no larger than half of a length of the first light-in side, an outer side of the second light source unit is aligned with a fourth side linked to the second light-in side, and a distance between an inner side and the outer side of the second light source unit is no larger than half of a length of the second light-in side.

Furthermore, an angel between a line from a center of an LED closest to the inner side of the first light source unit to a center of an LED closest to the inner side of the second light source and a normal line of the first light-in side satisfies the following formula:

$$θ < {sin}^{- 1} ( \frac{1}{{n}_{L G P}} sin {θ}_{H L A} ) ,$$

wherein θ signifies the angel between the line from the center of the LED closest to the inner side of the first light source unit to the center of the LED closest to the inner side of the second light source and the normal line of the first light-in side, n_{LGP} signifies index of refraction of the LGP, θ_{HLA} signifies a half-intensity viewing angle of the LEDs.

According to the present invention, a liquid crystal display (LCD) device comprising an LCD panel and a backlight module facing the LCD panel, the backlight module for generating light to the LCD panel. The backlight module comprises: a light guide plate (LGP); a first light source unit set up in a corner of a first light-in side of the LGP; a second light source unit set up in a corner of a second light-in side of the LGP; wherein the first light-in side is set up in opposition to the second light-in side, and the corner of the second light-in side is in diagonal to the corner of the first light-in side.

Furthermore, the first light source unit and the second light source unit are both light emitting diode (LED) light bars comprising a plurality of LEDs.

Furthermore, an outer side of the first light source unit is aligned with a third side linked to the first light-in side, and a distance between an inner side and the outer side of the first light source unit is no larger than half of a length of the first light-in side, an outer side of the second light source unit is aligned with a fourth side linked to the second light-in side, and a distance between an inner side and the outer side of the second light source unit is no larger than half of a length of the second light-in side.

Furthermore, an outer side of the first light source unit is aligned with a third side linked to the first light-in side, and a distance between an inner side and the outer side of the first light source unit is no larger than half of a length of the first light-in side, an outer side of the second light source unit is aligned with a fourth side linked to the second light-in side, and a distance between an inner side and the outer side of the second light source unit is no larger than half of a length of the second light-in side.

Furthermore, an angel between a line from a center of an LED closest to the inner side of the first light source unit to a center of an LED closest to the inner side of the second light source and a normal line of the first light-in side satisfies the following formula:

$$θ < {sin}^{- 1} ( \frac{1}{{n}_{L G P}} sin {θ}_{H L A} ) ,$$

wherein θ signifies the angel between the line from the center of the LED closest to the inner side of the first light source unit to the center of the LED closest to the inner side of the second light source and the normal line of the first light-in side, n_{LGP} signifies index of refraction of the LGP, θ_{HLA} signifies a half-intensity viewing angle of the LEDs.

The present invention provides a backlight module and an LCD device in which light enters the light guide plate in a corner. The entering light mix uniformly in the LGP without dark area, and the number of LED along with expense and energy consumption are reduced compared to that of a single short light-in side backlight module.

### BRIEF DESCRIPTION OF THE DRAWINGS

FIG. 1 shows backlight module according to prior art.

FIG. 2 shows a display device according to a preferred embodiment of the present invention.

FIG. 3 shows a light source unit and a light guide plate (LGP) in a backlight module according to a preferred embodiment of the present invention.

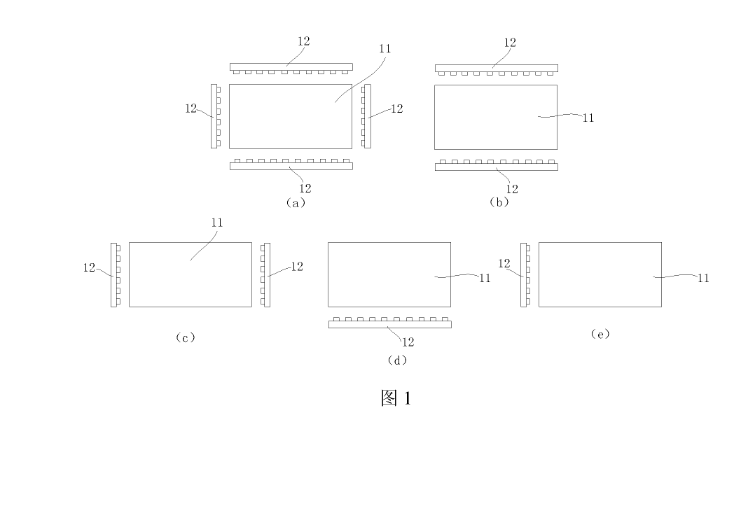

### DETAILED DESCRIPTION OF THE PREFERRED EMBODIMENTS

The accompanying drawings are included to provide a further understanding of the invention, and are incorporated in and constitute a part of this specification. The drawings illustrate embodiments of the invention and, together with the description, serve to explain the principles of the invention.

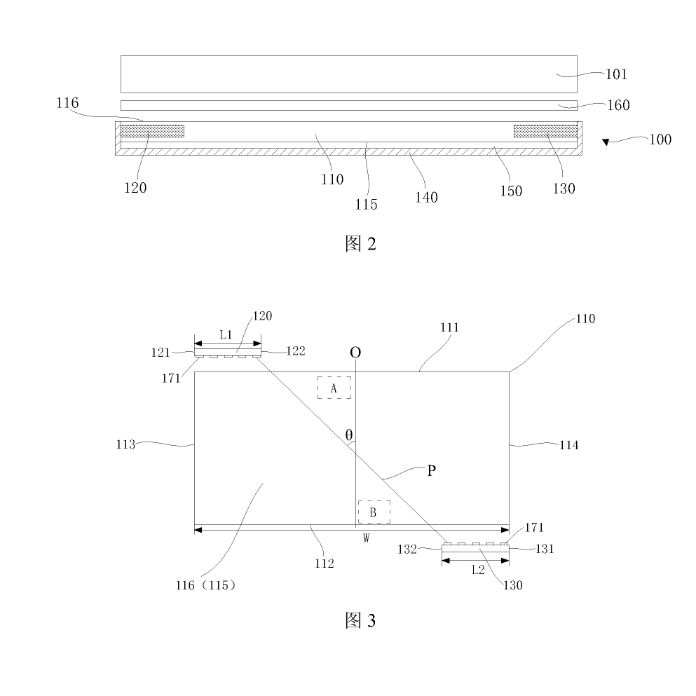

FIG. 2 shows a display device according to a preferred embodiment of the present invention. FIG. 3 shows a light source unit and a light guide plate (LGP) in a backlight module according to a preferred embodiment of the present invention.

Please refer to FIG. 2 and FIG. 3, a backlight module 100 is set up in opposition to an LCD panel 101, forming an LCD device. The backlight module 100 provides light to the LCD panel 101, so that the LCD panel 101 displays images. The backlight module 100 comprises a LGP 110, a first light source unit 120 and a second light source unit 130, a back plate 140, a reflector sheet 150 and an optical film 160.

The LGP 110 can be rectangle and be carried on the back plate 140. The LGP 110 comprises a first light-in side 111, a second light-in side 112, a third side 113 and a fourth side 114. The first light-in side 111 and the second light-in side 112 are both the longer sides of the LGP 110 and are set up parallely and in opposition. The third side 113 and the fourth side 114 are both the shorter sides of the LGP 110 and are set up parallely and in opposition. It has to be pointed out that the first light-in side 111 and the second light-in side 112 can also be the shorter sides of the LGP 110 and be set up parallely and in opposition Likewise, the third side 113 and the fourth side 114 can also be the longer sides of the LGP 110 and be set up parallely and in opposition. The LGP 110 also comprises a bottom side 115 and a light-out side 116 (i.e. top side) set up in opposition to the bottom side 115.

The first light source unit 120 can be set up in a corner of the first light-in side 111, likewise the second light source unit 130 can be set up in a corner of the second light-in side 112, and the corner of the second light-in side 112 is in diagonal to the corner of the first light-in side 111. The light from the first light source unit 120 and the second light source unit 130 enters the LGP 110 through the first light-in side 111 and the second light-in side 112 respectively and being mixed, and the uniformly mixed light projects the LGP 110 through the light-out side 116.

The reflector 150 is set up between the LGP 110 and the back plate 140 to reflect the projecting light from the bottom side 115 of the LGP 110 back to the LGP 110 to improve the efficiency of light-using. The optical film 160 is set up on the LGP 110 to improve the optical effects of the projecting light from the light-out side 116 of the LGP 110.

In the embodiment, the first light source unit 120 and the second light source unit 130 can both be LED light bars comprising a plurality of individual LEDs 171 set up on Printed Circuit Board (PCB, not shown). PCB provides power to the plurality of individual LEDs 171 to make them illuminate.

Furthermore, to prevent vegneting in the LGP 110 due to the first light source 120 and the second light source 130 locates in the first light-in side 111 and the second light-in side 112 respectively (i.e. the dark zone as a result from the non-light source unit corner on the LGP 110 does not receive light), an outer side 121 of the first light source unit 120 is aligned with the third side 113 linked with the first light-in side 111, and a distance L1 between an inner side 122 of the first light source unit 120 and the outer side 121 of that is no larger than half of a length W of the first light-in side 111. Likewise, an outer side 131 of the second light source unit 130 is aligned with the fourth side 114 linked with the second light-in side 112, and a distance L2 between an inner inside 132 of the second light source unit 130 and the outer side 131 of that is no larger than half of a length W of the second light-in side 112.

In addition, an angel between a line P from a center of the LED 171 closest to the inner side 122 of the first light source unit 120 to a center of the LED 171 closest to the inner side 132 of the second light source 130 and a normal line O of the first light-in side 111 (or the second light-in side 112) satisfies the following formula (1)

$$θ < {sin}^{- 1} ( \frac{1}{{n}_{L G P}} sin {θ}_{H L A} ) \qquad ( 1 )$$

In the formula, θ signifies the angel between a line P from the center of the LED 171 closest to the inner side 122 of the first light source unit 120 to the center of the LED 171 closest to the inner side 132 of the second light source 130 and a normal line O of the first light-in side 111, n_{LGP} signifies index of refraction of the LGP 110, θ_{HLA} signifies a half-intensity viewing angle meaning the corresponding beam angle when illumination intensity of the LEDs 171 decays from the maximum value to a half of maximum value. When the formula (1) is satisfied, the sufficient illumination desity of the zone in opposition to the non-light source unit corner on the LGP 110 (i.e. the right area A of the first light source unit 120 and the left area B of the second light source unit 130 in FIG. 3) is guaranteed, thus the light entering the LGP 110 can be mixed uniformly in the LGP 110.

In addition, in comparision with the conventional single short light-in side backlight module, the number of the LEDs 171 used in the example embodiment according to the present invention is significantly reduced, resulting in reduction of cost.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A backlight module applied in a liquid crystal display (LCD) device comprising:
a light guide plate (LGP);
a first light source unit set up in a corner of a first light-in side of the LGP;
a second light source unit set up in a corner of a second light-in side of the LGP;
wherein the first light-in side is set up in opposition to the second light-in side, and the corner of the second light-in side is in diagonal to the corner of the first light-in side;
wherein an outer side of the first light source unit is aligned with a third side linked to the first light-in side, and a distance between an inner side and the outer side of the first light source unit is no larger than half of a length of the first light-in side, an outer side of the second light source unit is aligned with a fourth side linked to the second light-in side, and a distance between an inner side and the outer side of the second light source unit is no larger than half of a length of the second light-in side.

2. The backlight module of claim 1, wherein the first light source unit and the second light source unit are both light emitting diode (LED) light bars comprising a plurality of LEDs.

3. The backlight module of claim 2, wherein an angel between a line from a center of an LED closest to the inner side of the first light source unit to a center of an LED closest to the inner side of the second light source and a normal line of the first light-in side satisfies the following formula:
$$θ < {sin}^{- 1} ( \frac{1}{{n}_{L G P}} sin {θ}_{H L A} ) ,$$
wherein θ signifies the angel between the line from the center of the LED closest to the inner side of the first light source unit to the center of the LED closest to the inner side of the second light source and the normal line of the first light-in side, n_{LGP} signifies index of refraction of the LGP, θ_{HLA} signifies a half-intensity viewing angle of the LEDs.

4. A backlight module applied in a liquid crystal display (LCD) device comprising:
a light guide plate (LGP);
a first light source unit set up in a corner of a first light-in side of the LGP;
a second light source unit set up in a corner of a second light-in side of the LGP;
wherein the first light-in side is set up in opposition to the second light-in side, and the corner of the second light-in side is in diagonal to the corner of the first light-in side.

5. The backlight module of claim 4, wherein the first light source unit and the second light source unit are both light emitting diode (LED) light bars comprising a plurality of LEDs.

6. The backlight module of claim 4, wherein an outer side of the first light source unit is aligned with a third side linked to the first light-in side, and a distance between an inner side and the outer side of the first light source unit is no larger than half of a length of the first light-in side, an outer side of the second light source unit is aligned with a fourth side linked to the second light-in side, and a distance between an inner side and the outer side of the second light source unit is no larger than half of a length of the second light-in side.

7. The backlight module of claim 5, wherein an outer side of the first light source unit is aligned with a third side linked to the first light-in side, and a distance between an inner side and the outer side of the first light source unit is no larger than half of a length of the first light-in side, an outer side of the second light source unit is aligned with a fourth side linked to the second light-in side, and a distance between an inner side and the outer side of the second light source unit is no larger than half of a length of the second light-in side.

8. The backlight module of claim 7, wherein an angel between a line from a center of an LED closest to the inner side of the first light source unit to a center of an LED closest to the inner side of the second light source and a normal line of the first light-in side satisfies the following formula:
$$θ < {sin}^{- 1} ( \frac{1}{{n}_{L G P}} sin {θ}_{H L A} ) ,$$
wherein θ signifies the angel between the line from the center of the LED closest to the inner side of the first light source unit to the center of the LED closest to the inner side of the second light source and the normal line of the first light-in side, n_{LGP} signifies index of refraction of the LGP, θ_{HLA} signifies a half-intensity viewing angle of the LEDs.

9. A liquid crystal display (LCD) device comprising an LCD panel and a backlight module facing the LCD panel, the backlight module for generating light to the LCD panel, the backlight module comprising:
a light guide plate (LGP);
a first light source unit set up in a corner of a first light-in side of the LGP;
a second light source unit set up in a corner of a second light-in side of the LGP;
wherein the first light-in side is set up in opposition to the second light-in side, and the corner of the second light-in side is in diagonal to the corner of the first light-in side.

10. The LCD device of claim 9, wherein the first light source unit and the second light source unit are both light emitting diode (LED) light bars comprising a plurality of LEDs.

11. The LCD device of claim 9, wherein an outer side of the first light source unit is aligned with a third side linked to the first light-in side, and a distance between an inner side and the outer side of the first light source unit is no larger than half of a length of the first light-in side, an outer side of the second light source unit is aligned with a fourth side linked to the second light-in side, and a distance between an inner side and the outer side of the second light source unit is no larger than half of a length of the second light-in side.

12. The LCD device of claim 10, wherein an outer side of the first light source unit is aligned with a third side linked to the first light-in side, and a distance between an inner side and the outer side of the first light source unit is no larger than half of a length of the first light-in side, an outer side of the second light source unit is aligned with a fourth side linked to the second light-in side, and a distance between an inner side and the outer side of the second light source unit is no larger than half of a length of the second light-in side.

13. The LCD device of claim 12, wherein an angel between a line from a center of an LED closest to the inner side of the first light source unit to a center of an LED closest to the inner side of the second light source and a normal line of the first light-in side satisfies the following formula:
$$θ < {sin}^{- 1} ( \frac{1}{{n}_{L G P}} sin {θ}_{H L A} ) ,$$
wherein θ signifies the angel between the line from the center of the LED closest to the inner side of the first light source unit to the center of the LED closest to the inner side of the second light source and the normal line of the first light-in side, n_{LGP} signifies index of refraction of the LGP, θ_{HLA} signifies a half-intensity viewing angle of the LEDs.
